(19) United States
(12) Patent Application Publication
(10) Pub. No.: US 2007/0152363 A1
(43) Pub. Date: Jul. 5, 2007

(54) GEL PRODUCTION VIA MULTI-STREAM MIXING

(75) Inventors: Redouane Begag, Hudson, MA (US); Jong Ho Sonn, Worcester, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS, INC., Northborough, MA (US)

(21) Appl. No.: 11/618,009

(22) Filed: Dec. 29, 2006

Related U.S. Application Data
(63) Continuation-in-part of application No. 60/755,564, filed on Dec. 29, 2005.

(51) Int. Cl. B29C 65/00

(52) U.S. Cl. 264/41; 264/299

(57) ABSTRACT

This invention relates to methods of preparing porous gels with improved consistencies and properties by stabilizing gel precursors. It further relates to processing of precursors, sol and other ingredients for casting gels in a continuous fashion.

### CROSS-REFERENCES TO RELATED APPLICATIONS

This application claims benefit of priority from U.S. Provisional Patent Application 60/755,564, filed Dec. 29, 2005. The previous application is hereby incorporated by reference in their entireties as if fully set forth.

### FIELD OF THE INVENTION

This invention relates to methods of preparing precursors, sols and porous gels.

### DESCRIPTION OF THE INVENTION

This invention relates to methods of preparing porous gel materials by reducing the amount of instability while preparing, or casting, the gel material. The methods of the invention include means to stabilize gel precursors to lower the incidence of undesirable, or premature, polymerization that results in gels with inconsistent structures, characteristics, and/or properties. In some aspects of the invention, the gel precursors are maintained separately from the diluents, additives and/or catalyst used in preparing gels until the precursors are combined with the diluents, additives and/or catalyst in a continuous method of gel preparation.

Gel materials may be prepared in a variety of ways. The sol-gel technique is one such method whereby gelation of precursor materials, which polymerize to make up the final gel product, is induced typically in the sol phase. Such a “sol-gel” technique describes the reaction mechanism used to transform the sol, a colloidal suspension of solid particles in a liquid, into a highly branched polymeric molecule that extends through the volume occupied by the sol.

The sol-gel method typically involves batch hydrolysis of precursor materials and condensation reactions where polymerization and gelling occurs. An example of batch hydrolysis is seen with the metal alkoxide tetraethylorthosilicate (TEOS) monomer (Si(OEt)₄) precursor, which may be partially hydrolyzed by water (to form HO—Si(OEt)₃, (HO)₂—Si(OEt)₂, (HO)₃—Si(OEt)₁) or fully hydrolyzed ((HO)₄Si). The extent of hydrolysis may be controlled so that on average, each monomer is hydrolyzed to a desired level up to fully hydrolyzed on average. Each hydrolyzed monomer can undergo a condensation reaction with another monomer to form linked monomers, which are also referred to as polymers. A hydrolyzed monomer may also react with a polymer to form a larger polymer.

One partially hydrolyzed HO—Si(OEt)₃ monomer may polymerize with an unhydrolyzed TEOS monomer to form (OEt)₃Si—O—Si(OEt)₃ with the release of EtOH or two partially hydrolyzed HO—Si(OEt)₃ monomers may polymerize to form (OEt)₃Si—O—Si(OEt)₃ with the release of H₂O. A polymer is made up of two or more linked monomers. Linkage of a small number of monomers may be referred to as oligomers. Linkage of larger numbers of monomers may be referred to as resulting in polymers. While all oligomers are polymers, not all polymers are oligomers. Linkage formation may be enhanced by the use of a catalyst for the hydrolysis/condensation reactions.

The linkage, or polymerization, of monomers to monomers, as well as monomers to oligomers, monomers to polymers, oligomers to polymers, and polymers to polymers, through condensation reactions forms Si—O—Si bonds, with branching occurring via the additional reaction sites available at each Si atom. The ongoing polymerization reactions result in the creation of a highly branched, polymer from enormous numbers of monomers. The polymer may become a large enough network to extend through the volume containing the reactions. The network may become large enough to be macroscopic, or visible to the unaided eye. The porous structure of the network may be “open” or “open-pored” in that the liquid within the pores may be removed to result in a porous skeleton as a solid material.

In certain instances however, a batch procedure has limitations. One such case is in a continuous gel casting scheme where a batch hydrolyzed sol is continuously cast into a mold. One example is with a batch hydrolyzed sol containing a catalyst, where portions of the catalyzed sol are consecutively gelled over a period of time. The hydrolyzed sol has been observed to be unstable under some conditions to result in polymerization prior to being transferred for casting. This results in inconsistent gel times and uneven gel properties throughout the production process. Sudden gelation, where the entire hydrolyzed sol quickly gels, is an example of the particularly detrimental effects of such instability because they often resulting in clogged flow lines and require a large amount of time and labor for clean up.

The continuous casting of silica gels is a more specific example. Here, a sol containing a silica gel precursor, such as a hydrolyzed alkoxysilane like TEOS, and a diluent (such as ethanol), are mixed and later catalyzed to form a gel. However, prior to addition of catalyst, an unstable hydrolyzed sol results which may be attributed to polysilicates forming continuously. As a result, gels cast from the early portions of the sol exhibit different gel times and consistencies than those from the later portions of the sol. Gel, or gelation, time may be defined as the time interval between the adding of catalyst to the sol and when the sol polymerizes into a continuous network and/or displays the characteristic of increased resistance to flowing.

Without being bound by theory, and offered to improve the understanding of the invention, the above issues may be remedied by changing the speed of the casting process, changing the catalyst concentration (ratio of catalyst to gel precursor), or a combination of both. Such control methods are undesirable because they can affect critical product properties (e.g., strengthening time and monomer content of the sol and/or gel) in adverse ways. Furthermore, the gel properties which change are difficult to measure in a continuously automated system, and it is impractical to employ manual measurement of gel properties within the time frame required to provide feedback to the process.

The above measures are also inadequate in light of the observation that instability can also arise when using gel precursors that are in partially polymerized form, like in cases of a precursor solution containing both monomers and polymers as non-limiting examples. One non-limiting example is a sol solution comprising alkoxysilanes, such as TEOS, and polyalkoxysilanes, like polyethoxysilane. Due to greater polymerization potential, higher monomer/polymer ratio precursors often display more pronounced instability than those with lower ratios when in the presence of a diluent and/or other ingredients.

An aspect of the disclosed invention is a method whereby gel materials, such as silica aerogels, can be prepared without the aforementioned problems and/or batch procedure. In some embodiments of the invention, instability in hydrolyzed sols is reduced by keeping hydrolyzed gel precursors (such as partially polymerized silica precursors) separate from diluents (such as alcohols) until they are combined to form a mixture of the two. One non-limiting example is to keep the precursor(s) in a different container or location from the diluent(s) until they are combined.

In other embodiments, instability is reduced by keeping the precursor(s) separate from the diluent(s) as well as any catalyst to be used until a combination of the precursor(s) and diluent(s), or precursor(s) and catalyst(s), or precursor(s) and diluent(s) and catalyst(s). One non-limiting example is to keep the precursor(s) in a different container or location from the diluent(s) as well as catalyst(s) until they are combined. In another non-limiting example, the precursor(s) are maintained separately from a mixture of diluent(s) and catalyst(s).

In other embodiments, instability is reduced by keeping the precursor(s) separate from the diluent(s) as well as any additives (such as opacifiers, fire retardants, fungicides, antimicrobials etc.) be used until a combination of the precursor(s) and diluent(s), or precursor(s) and additive(s), or precursor(s) and diluent(s) and additives(s). One non-limiting example is to keep the precursor(s) in a different container or location from the diluent(s) as well as additives(s) until they are combined. In another non-limiting example, the precursor(s) are maintained separately from a mixture of diluent(s) and additive(s).

In other embodiments, instability is reduced by keeping the precursor(s), diluent(s), additives and catalyst away from one another until a combination of any two, three or four groups of said elements(i.e. precursor(s), diluents(s), catalyst(s) and additive(s)) are obtained. One non-limiting example is to keep said elements in a different container or location from one another until they are combined. In another non-limiting example, the precursor(s) are maintained separately from a mixture of diluent(s), catalyst(s) and additive(s).

Thus, the invention includes separating the ingredients, or reagents (e.g., the hydrolyzed gel precursor(s) and the diluent(s), and optionally catalyst(s)), and streaming them into a volume where they are mixed briefly prior to immediate transfer to casting. In some embodiments, the precursor(s) and diluent(s) are mixed briefly before the addition of the catalyst(s) which precedes the immediate transfer to casting. The invention may also be viewed as including methods wherein the precursor(s), diluent(s), and catalyst(s) are provided by separate sources which are operably connected to feed, or stream, the individual ingredients into one or more mixers to form a mixture for preparing a porous gel material.

The invention relates to minimizing the amount of time the hydrolyzed precursor(s) are exposed, or interact with, other reagents before casting. In many embodiments, the other reagents are the diluent(s), and optionally catalyst(s). In other embodiments, other reagents are optional additives to the mixture, which are also kept separate from the precursor(s). Alternatively, the optionally additives may be maintained with the precursor(s) where they do not contribute to instability.

In further embodiments, a method of the invention uses a chemical catalyst in combination with a non-chemical catalyst. One non-limiting example of a non-chemical catalyst is heat or radiation used to induce, or further induce, gelation.

The separation of reagents and use of brief mixing times advantageously allows for the invention to be practiced by the use of multi-stream methods with mixing to combine separate reagents and optional additives. In some embodiments, the mixing is brief, such as for a short period of time like a few seconds, with less than 2 seconds as one non-limiting example.

In an embodiment, catalyst as used herein, may refer to a catalyst that may help hydrolysis/condensation of a precursor for form a sol. In another embodiment, catalyst may refer to a catalyst used to help the sol form into a gel.

In additional embodiments, a method of the invention may be used to continuously form a sheet of porous gel material on a moving element with edges that define the volume of the sheet. The method may include dispensing a pre-gel mixture onto the moving element at a predetermined rate which allows the porous gel material to form as the mixture moves along the element. One non-limiting example of a moving element is a conveyer belt.

In yet further embodiments, the porous gel material may be formed as a fiber-reinforced gel composite with two parts. The first part is the gel matrix, and the second part is the reinforcing fibers, which may be in the form of a lofty fibrous structure (e.g. batting) containing either thermoplastic polyester or silica fibers. In some methods, the reinforcing fibers can include randomly distributed short fibers, such as microfibers, which may (or may not) extend throughout the batting. The fibrous reinforcing fibers may be introduced onto a moving element for combination with the pre-gel mixture prior to gelation.

The details of additional embodiments of the invention are set forth in the accompanying drawings and the description below. Other features and advantages of the invention will be apparent from the drawings and detailed description, and from the claims.

### BRIEF DESCRIPTION OF THE DRAWINGS

FIG. 1 is a schematic illustrating one embodiment of the invention for a continuous method of preparing a mixture to cast a porous gel material. The gel precursor(s), diluent(s), and catalyst(s) are all maintained separately and separate lines are used to feed, or flow, each into combination with the others. As indicated, the diluent(s) and catalyst(s) are fed into a first mixer (“Mixer 1”) to form a first mixture. The first mixture, as well as the precursor(s), are separately fed to a second mixer (“Mixer 2”) for their combination to form a mixture for transfer to casting.

FIG. 2 is a schematic illustrating another embodiment of the invention for preparing a mixture to cast a porous gel material. Like in FIG. 1, the gel precursor(s), diluent(s), and catalyst(s) are all maintained separately and separate lines are used to feed, or flow, each into combination with the others. As indicated, the precursor(s) and diluent(s) are fed into a first mixer (“Mixer 1”) to form a first mixture. The first mixture, as well as the catalyst(s), are separately fed to a second mixer (“Mixer 2”) for their combination to form a mixture for transfer to casting.

FIG. 3 is a schematic illustrating another embodiment of the invention for preparing a mixture to cast a porous gel material. Like in FIGS. 1 and 2, the gel precursor(s), diluent(s), and catalyst(s) are all maintained separately and separate lines are used to feed, or flow, each into combination with the others. As indicated, all three reagents are fed into a single mixer (“Mixer 1”) to form a mixture which is transferred to casting.

### DETAILED DESCRIPTION OF THE INVENTION

This invention discloses methods of casting porous gel materials with improved gel consistency as well as properties and/or characteristics. In some embodiments, the methods are continuous operations in that they utilize streams, or flows, of reagents used in the gel casting process. A “continuous method” comprises at least one step performed in a manner so that continuous passage of material occurs through that step and/or subsequent stages (e.g., vessels, lines, and/or reactors) of the method. The continuous flow does not have to be on a constant, perpetual, basis but rather continues for a period of time sufficient for continuous passage of material to occur. This is in contrast to a batch process or procedure where a single operation is used to combine a quantity of material for use in casting. Thus the invention relates to a non-batch, or continuous over a period of time, method of combining the reagents for a porous gel material. This may also be considered a continuous, or non-batch means of casting a porous gel material.

Without being bound by theory, and offered to improve the understanding of the invention, the invention is based in part on the discovery that diluent addition to gel precursors can contribute to instability and so results in undesirable effects in gel production. Therefore, the invention discloses methods that include maintaining or keeping gel precursors free of added diluent until the precursor is to be combined with catalyst and used for gel production.

One aspect of the invention relates to a method of continuously casting a porous gel material. The method may comprise continuously contacting at least one gel precursor with at least one diluent and at least one catalyst. The contacting forms a pre-gel mixture which may then be transferred to a cast or mold in a continuous manner. In many embodiments, the transfer is continuous over time such that the portion of the pre-gel mixture containing all reagents needed for gel formation is cast as the next portion of the pre-gel is formed by the combination of the reagents. These consecutive portions are continually formed and continually transferred over time in the practice of the invention. In some embodiments, the precursor, diluent, and catalyst are from separate sources such that they are physically separate and not in combination until use in the methods of the invention. They may be in different containers or different compartments of the same container as non-limiting examples. In the disclosed methods, the different sources are linked such that they deliver the precursor, diluent, and catalyst into mixer(s), such as by individual feed streams. In some of the methods, either the precursor is from a separate source from the diluent and catalyst, or the catalyst is from a separate source from the precursor and diluent. In other embodiments, either the precursor is from a source separate from the diluent, or the diluent is from a source separate from the catalyst. The isolation of the catalyst, from precursor and diluent, is readily apparent where the catalyst includes a non-chemical agent.

The gel precursor is a monomer, an oligomer, a polymer, or any combination of two or more of these, as described herein. In other embodiments, the at least one precursor may be homogeneous, such that a homopolymeric gel results, or heterogeneous, such that a heteropolymeric gel results. In additional embodiments, the precursor is a mixture of both monomers and polymers. One non-limiting example of precursor material for use in the invention is partially hydrolyzed ethylsilicates, a preparation, by weight, of less than about 25% ethylsilicate, less than about 10% EtOH, and less than about 80% ethylpolysilicate. In many embodiments, the at least one gel precursor is maintained in a location separate from the at least one diluent and the at least one catalyst. In an embodiment, precursor is a hydrolyzed precursor and in another embodiment, precursor is a non-hydrolyzed precursor. In yet another embodiment, a non-hydrolyzed precursor may be hydrolyzed during the processes described by different embodiments of the present patent application.

The invention is not limited by the nature or type of the precursor(s) used. The precursor(s) may be inorganic, organic or a combination of inorganic/organic hybrid materials. Non-limiting examples of inorganic materials include alkoxides and aryloxides of metals, non-metals and semi-metals, silanes, siloxanes, zirconia, yttria, hafnia, alumina, titania, ceria, and silica, magnesium oxide, calcium oxide, magnesium fluoride, or calcium fluoride, or any combination of two or more of the above. Precursor may further include derivatives of any of the following or an equivalent thereof. Some example sof derivatives include alkyl alkoxy silanes, phenul alkoxy silanes, vinyl alkoxy silanes, isocyanatopropyl trialkoxy silane, tromethoxysilyl propyl methacrylate, aminoalkoxy silane or mixtures thereof. Further precursors may be understood in the context of prior art. Non-limiting examples of organic materials include polyacrylates, polymethacrylates, polyolefins, polystyrenes, polyacrylonitriles, polyurethanes, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, or agarose, or any combination of two or more of the above. Non-limiting examples of specific a gel precursor include silicon alkoxides (like TEOS or TMOS), alkyl alkoxysilanes, silicon tetrachloride, sodium silicate, different Dynasil® formulations from Degussa, Silbond® formulations from Silbond Corp., and other silica precursors available from commercial sources. Partially polymerized precursors such as those comprising alkylsilicates and polyalkylsilicates may also be used for the purposes of the invention.

In some methods of the invention, the at least one gel precursor comprises at least one metal alkoxide monomer. In other embodiments, the at least one gel precursor comprises at least one metal alkoxide monomer and at least one metal alkoxide oligomer or polymer. In other embodiments, the at least one gel precursor comprises at least one alkoxysilane, optionally with at least one polyalkoxysilane.

In many embodiments, the precursor(s) will be partially or fully hydrolyzed. Non-limiting examples of partial hydrolysis include at least about 1%, at least about 2%, at least about 3%, at least about 4%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%. Hydrolyzed precursor(s) may be advantageously used because they are ready to undergo the condensation reaction and so are responsive to the use of one or more catalyst(s). In other embodiments, the precursor(s) are maintained in an unhydrolyzed form but are hydrolyzed, or subject to hydrolysis (e.g. contact with a hydrolytic agent or exposure to hydrolytic conditions as non-limiting examples), before they are used in the methods of the invention.

The invention may also be practiced with precursors that contain an amount of diluent. Non-limiting examples include cases of commercially available precursors that already contain an amount of diluent, which may be a product of a polymerization reaction, such as the condensation of TEOS described herein to result in EtOH, a possible diluent of the invention. Another non-limiting example of precursors that contain an amount of diluent is seen with gel precursors that contain diluent during or after hydrolysis and/or partial condensation. The presence of diluent is not recognized as having a negative effect on stability. This is in contrast to the present invention's observation that the presence of diluent results in precursor instability. In some embodiments, the instability is seen with precursor material that contains molecules of both monomers and polymers. Higher ratios of monomers to polymers in the precursor material appears to correlate with increased instability upon the addition of diluent. Thus the invention may be advantageously used with precursor materials containing only monomers, as well as those with a monomer to polymer ratio of about 1:10⁴ or higher, about 1:10³ or higher, about 1:10² or higher, about 1:10 or higher, about 1:9 or higher, about 1:8 or higher, about 1:7 or higher, about 1:6 orhigher, about 1:5 or higher, about 1:4 or higher, about 1:3 or higher, about 1:2 or higher, about 1:1 or higher, about 3:2 or higher, about 2:1 or higher, about 5:2 or higher, or about 3:1 or higher.

The invention may be considered as improving or increasing the stability of the precursor(s) by keeping or maintaining it/them from added diluent(s) and/or catalyst(s). In some cases, the methods keep the precursor(s), optionally containing some amount of diluent, from any additional diluent(s) and/or catalyst(s) until the precursor is to be used as described herein. In many embodiments, the precursor is combined with added diluent, before contact between precursor and catalyst, to further improve stability.

In some embodiments, the diluent(s) is/are added subsequent to the initiation of precursor hydrolysis, when instability can occur. Therefore, diluent that is present while the precursor is hydrolyzed, or that is present after hydrolysis is complete, is not a diluent added to, or combined with, a precursor as present in a method of the invention. Put differently, separation of precursor(s) and diluent(s), in the context of the invention, refers to maintaining separation between the precursor(s), after a desired extent of hydrolysis is achieved, and the diluent which is to be subsequently added. As a non-limiting example, a silica precursor such as TEOS may be 20% hydrolyzed before the subsequent addition of diluent(s) and catalyst(s). The subsequent addition of a desired amount of diluent is important in many respects, with the control of resultant gel density being an important, but non-limiting, example.

As is evident from the above, the precursor(s) of the invention are often in the form of a liquid, possibly containing a suspension of precursor material. In embodiments where the precursor is unhydrolyzed, it may be in solid form until being subjected to hydrolysis (e.g. contact with a hydrolytic agent or exposure to hydrolytic conditions as non-limiting examples), when it will be in the form of a liquid or suspension.

In contrast, a diluent of the invention is in liquid form, and does not hydrolyze precursor material. Diluents for use in the practice of the invention include, but are not limited to, ethanol, methanol, propanol, acetone, 2-methoxy ethanol, isopropanol, isobutanol, acetonitrile, ketones, alkylketones, ethers, acetic acid, and other solvents. In some embodiments, a diluent does not further hydrolyze, and so does not further activate a precursor for condensation. In other embodiments, a diluent is readily removed from the liquid phase after gel (solid network) formation.

The catalysts of the invention, however, may be in solid or liquid form. Non-limiting examples of catalysts include primary, secondary and tertiary amines as well as ammonia, potassium hydroxide, or sodium hydroxide. Additional non-limiting examples include acid catalysts like fluorhydric acid, nitric acid, acetic acid, sulfuric acid, hydrochloric acid, phosphoric acid, and other pH lowering agents. While both base and acid catalyzed polymerization may be used, based catalysis is used in many embodiments of the invention. Therefore, the invention includes the use of solid or liquid forms of potassium hydroxide or sodium hydroxide as non-limiting examples.

In some embodiments of the invention, at least one diluent and at least one catalyst are first contacted to form a first mixture before either the diluent or the catalyst is contacted with the precursor. The first mixture is kept separate from the precursor in accordance with the invention. The diluent and catalyst may be contacted in a first mixing area. Embodiments of the invention include the continuous preparation of a first mixture, whether with or without a first mixing area. Alternatively, a discontinuous, or batch, method may be used. In additional embodiments, the first mixture of diluent and catalyst is flowed or streamed into the first mixing area.

After formation, the combination of the first mixture of diluent and catalyst is contacted, preferably continuously, with a gel precursor to form a second, or pre-gel, mixture. In some embodiments, this contacting occurs in a second mixing area. In additional embodiments, the precursor and the first mixture of diluent and catalyst are flowed or streamed into the second mixing area.

The methods of the invention may be embodied in an apparatus comprising sources of precursor, diluent, and catalyst as well as mixer(s) and a moving element, such as a conveyor belt or apparatus. In methods wherein energy is used as part of the catalyst, The energy may be provided via an energy dissipation zone on the moving conveyor apparatus so that catalysis may be enhanced by an energy dissipation process. As non-limiting examples, a controlled flux of electromagnetic (ultraviolet, visible, infrared, microwave), acoustic (ultrasound), or particle radiation can be introduced across the width of a moving volume of mixed reagents contained by a conveyor belt to induce sufficient cross-linking of the polymers contained therein to achieve a gel point. The flux, as well as the point and the area of radiation, can be controlled along the conveyance apparatus to achieve an optimized casting rate and desirable gel properties by the time the terminus of the conveyor is reached, for a given section of gel. Energy may be used to induce gelation in addition to classical methods of chemical catalysis, such as in a pH change. Non-limiting embodiments of possible apparatuses include those shown and described in published U.S. Patent Application 2005/0046086, which is expressly incorporated herein as if fully set forth.

In some embodiments, the methods include controlling the timing of the gelation point with respect to the conveyor speed such that the material has adequate time to age and strengthen prior to any mechanical manipulation at the terminus of the conveyor apparatus. Although the diffusion of polymer chains and subsequent solid network growth are significantly slowed within the viscous gel structure after the gelation point, the maintenance of the original mixture for a period of time after gelation is essential to obtaining an aerogel that has the best thermal and mechanical properties. This period of time that the gel “ages” without disturbance is called “syneresis”. Syneresis conditions include time, temperature, pH, and solid concentration as non-limiting examples.

In alternative embodiments of the invention, a method of continuously casting a porous gel material by first combining at least one gel precursor and at least one diluent is disclosed. The at least one gel precursor is maintained in a location separate from the at least one diluent. After contacting at least one gel precursor with at least one diluent to form a first mixture, the method may comprise continuously contacting the first mixture with at least one catalyst to form a pre-gel mixture. The pre-gel mixture may then be transferred into a cast or mold in a continuous manner. As with other embodiments, the transfer may be continuous over time such that the portion of the pre-gel mixture containing all reagents is cast as the next portion of the pre-gel is formed by the combination of the first mixture and the catalyst(s).

The at least one precursor and at least one diluent may be contacted, preferably continuously, in a first mixing area to form the first mixture. The precursor and diluent may be flowed or streamed into each other or alternatively into the first mixing area. This mixture is kept separate from the at least one catalyst in accordance with the invention. The first mixture may then travel from the first mixing area to be continuously contacted with the catalyst in a second mixing area. The first mixture of precursor and diluent, as well as the catalyst, may be flowed or streamed into the second mixing area.

In other embodiments, the invention describes a method comprising continuously casting a porous gel material by first hydrolyzing, or subjecting to hydrolysis, gel precursor material to form at least one hydrolyzed gel precursor. The hydrolysis of gel precursor material may be partial or complete. Non-limiting examples of partial hydrolysis have been described herein. Methods to hydrolyze gel precursor material are known in the art, and as noted above, may include the presence of a small amount of diluent. Alternatively, the gel precursor may be exposed or subjected to hydrolytic conditions which favor hydrolysis of the gel precursor material. Gel precursor materials include the precursor materials described herein. The at least one gel precursor is optionally maintained in a location separate from diluent and catalyst.

The hydrolyzed gel precursor is then continuously contacted with at least one diluent and at least one catalyst to form a pre-gel mixture. The pre-gel mixture may then be transferred into a cast or mold in a continuous manner. As with other embodiments, the transfer may be continuous over time such that the portion of the pre-gel mixture containing all reagents is cast as the next portion of the pre-gel is formed by the combination of the first mixture and the catalyst(s).

Alternatively, and after preparation of the at least one gel precursor, it is contacted with at least one diluent to form a first mixture. The method may then comprise continuously contacting this first mixture with at least one catalyst to form a pre-gel mixture as described above.

In the absence of forming a first mixture, the precursor, diluent, and catalyst are continuously contacted in a mixing area. In some embodiments, the precursor, diluent, and catalyst are flowed or streamed into the mixing area.

As yet another embodiment of the invention, a method comprising separate combinations of a) a precursor and diluent and b) a catalyst and diluent is provided by the invention. The a) and b) combinations are then combined to form a pre-gel mixture which is transferred as described herein. The combination of precursor and diluent may be performed continuously, along with continuous combination of a) and b). The combination of catalyst and diluent may be performed continuously or in batch mode.

As used herein, the mixing areas of the embodiments of the invention may be in the form of a static or active mixer. Non-limiting examples, of areas where mixing occurs, include a vessel, a container, a flow line, or an equivalent structure where a static, active or other type of mixing process may occur. In active mixing, an element such as a rotor or a blade rotates to actively enhance the mixing where as in a static mixing a stationery element helps the mixing for example by way of inducing turbulent flow of a fluid flowed through, around or past it. In the practice of the invention, mixing or combining of reagents may occur continuously as indicated and may occur for a short period of time. Non-limiting examples of the time period used include less than about 1 second, less than about 2 seconds, less than about 3 seconds, less than about 4 seconds, less than about 5 seconds, less than about 6 seconds, less than about 7 seconds, less than about 8 seconds, less than about 9 seconds, less than about 10 seconds, less than about 12 seconds, less than about 14 seconds, less than about 16 seconds, less than about 18 seconds, or less than about 20 seconds, although short periods longer than about 20 seconds may also be used.

The description of the invention includes the Figures which provided representations of some embodiments of the present invention to illustrate how the hydrolyzed precursor is separate from the other reagents and combined therewith for a short time period before subsequent transfer to a cast or mold. It is pointed out that the mixers in indicated in each figure can be different types such as static, active, or a combination thereof. Each type of mixer provides its own unique advantage. For instance, static mixers are easier to clean and are in general safer. Active mixers on the other hand provide the benefit of working through situations such as increased viscosity of fluids within the mixer. In many embodiments of the invention, static mixers are used.

After transfer to a cast or mold, a pre-gel mixture forms a gel over time because it contains all the reagents for gel formation. As noted above, gelling is the formation of a three dimensional polymer network to form a solid porous material. Formation may be partial, where some gelling has occurred, or complete, wherein no further gelling occurs. Gelling may be detected as an increased resistance to flowing, or an increase in viscosity in the pre-gel mixture. Gel formation results in an initial “wet gel” or wet porous material because the diluent and other liquids, such as solvents, remain within the pores of the porous material.

The mixture may be combined with a reinforcing fibrous material in a cast or mold. The fibrous material may be comprised of very low denier fibers so that the resulting composite material, when dried into an aerogel or xerogel product by solvent extraction, maintains similar thermal properties to an aerogel or xerogel. But the fibers may result in a gel with stronger and/or more durable characteristics. The diameter of the fibers used may be in the range of about 0.1 to about 10,000 microns. In some cases nanofibers in the range of about 0.001 to about 100 microns are used. In addition to fibrous batting, crimped fibers can be distributed throughout the gel structure.

The fiber reinforcement may be a lofty fibrous structure (batting or web), but may also include individual randomly oriented short microfibers, and woven or non-woven fibers. More particularly, but non-limiting fiber reinforcements are based upon either organic (e.g. thermoplastic polyester, high strength carbon, aramid, high strength oriented polyethylene), low-temperature inorganic (various metal oxide glasses such as E-glass), or refractory (e.g. silica, alumina, aluminum phosphate, aluminosilicate, etc.) fibers. Typical, but non-limiting, examples include carbon nanofibers and carbon nanotubes with diameters as small as 0.001 microns.

A lofty batting as used herein is a fibrous material that shows the properties of bulk and some resilience (with or without full bulk recovery). One non-limiting form is a soft web of this material. The use of a lofty batting reinforcement material minimizes the volume of unsupported aerogel while avoiding substantial degradation of the thermal performance of the aerogel. Batting materials that have some tensile strength may be advantageous for introduction to a conveyor casting system described herein. Load transfer mechanisms can be utilized in the process to introduce delicate batting materials to the conveyor region prior to infiltration with a mixture flow.

Suitable fibrous materials for forming both the lofty batting and the x-y oriented tensile strengthening layers include any fiber-forming material. Non-limiting suitable materials include: fiberglass, quartz, polyester (PET), polyethylene, polypropylene, polybenzimid-azole (PBI), polyphenylenebenzo-bisoxasole (PBO), polyetherether ketone (PEEK), polyarylate, polyacrylate, polytetrafluoroethylene (PTFE), poly-metaphenylene diamine (Nomex), poly-paraphenylene terephthalamide (Kevlar), ultra high molecular weight polyethylene (UHMWPE) e.g. Spectra™, novoloid resins (Kynol), polyacrylonitrile (PAN), PAN/carbon, and carbon fibers.

As described herein, the cast or mold may be stationary or in motion. Moving casts or molds may be in the form of a conveyor belt. They may be used to produce a roll of porous gel material that is co-wound or co-rolled with a porous flow layer that facilitates solvent extraction using supercritical fluids processing methods. In some embodiments, an apparatus of the invention may have a very small footprint using these methods of the present invention to create gel materials in a roll rather than flat sheets. More specifically, a method for producing gel sheets in a continuous fashion is described in which gel sheets are produced by a disclosed method and are rolled into a plurality of layers. This provides a novel and effective way of producing gel sheets for efficient drying operations. In another feature, an optional spacer material is co-rolled with the gel sheets. Such a spacer material can be permeable or impermeable in nature. Depending on the permeability of the spacer material, one can obtain a favorable flow pattern during subsequent drying. Spacer material may also provide flow paths for subsequent silylation (aging) fluids to easily pass through. During drying they further help by proving flow paths that effectively reduce the thickness of the gel sheet to be extracted in a radial direction. These methods may be considered as continuous with combined casting and rolling processes.

In embodiments with a conveyor system, the conveyer may have molded edges that retain mixture volume and so act as the cast or mold. The gel mixture can be directly cast onto this type of conveyor surface. After gelation, the porous gel material may be cut and conveyed to an area for further processing or rolled. In some embodiments, comprising a flexible, fiber-reinforced gel composite, the rolling may be with a flexible, porous flow layer to generate a co-rolled form of the material. These formed rolls of gel composite material and flow layer are particularly amenable to interstitial solvent removal using supercritical processing methods. Alternatively, the conveyor has molds placed upon it, and the mold volumes can be continuously filled with freshly catalyzed sol.

In some embodiments, a moving conveyor apparatus may include a counter-rotating molding capability. One non-limiting example is with two sets of rollers to mechanically roll a fiber-reinforced, nanoporous gel composite, with or without a porous flow layer. Alternatively the same process utilizing a moving conveyor belt with only a single molding surface (a continuously rotating bottom belt with molded sides) is used. In other embodiments, a monolithic gel sheet without fiber reinforcement is formed from a mixture continuously by deposition of a mixture onto a moving conveyor, optionally with one or two sets of counter-rotating conveyor molding rollers.

In some embodiments, and either during formation of the porous gel material or after its formation, the methods of the invention may comprise aging the porous gel material. Aging is an action, such as the application of energy or an aging agent, to increase gel rigidity and resistance to drying effects. Aging step may also include a step of treatment with a hydrophobic agent. A non-limiting example of a drying effect includes pore collapse in the porous gel material, which collapse is resisted in aged gel materials. One non-limiting example of energy based aging includes the application of heat as known to the skilled person. Non-limiting examples of an aging agent includes the use of chemical agents like hexamethyldisiloxane (HMDS), hexamethyl disiloxane, silanes, siloxanes, silicones or other chemicals known to the skilled person.

The methods of the invention may further comprise drying a wet porous gel material by any suitable means known to the skilled person. As understood in the field, different drying conditions result in the formation of gels with different properties, such as an aerogel or xerogel, from a wet porous gel material. Methods of drying gels for generating aerogels or xerogels are well known. Kistler (J. Phys. Chem., 36, 1932, 52-64) describes a drying process where the gel solvent is maintained above its critical pressure and temperature (under “supercritical” conditions). Due to the absence of any capillary forces, such supercritical drying maintains the structural integrity of the gel to produce aerogels.

Other conditions for preparing aerogels are also known. U.S. Pat. No. 4,610,863 describes a process where the gel solvent is exchanged with liquid carbon dioxide and subsequently dried at conditions where carbon dioxide is in a supercritical state. Such conditions are milder than the one described by Kistler. U.S. Pat. No. 6,670,402 teaches drying via rapid solvent exchange of solvent inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form of a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure.

U.S. Pat. No. 5,565,142 describes a process where the gel surface is modified such that it is more hydrophobic and stronger to resist any collapse of the structure during ambient or subcritical drying. Surface modified gels are dried at ambient pressures or at pressures below the critical point (subcritical drying). Products obtained from such ambient pressure or subcritical drying are often referred to as xerogels.

Thus the methods of the invention may further comprise drying a porous gel material to remove diluent and other liquids. The drying may be allowed to continue until the porous gel material is dried. In some embodiments, the drying occurs at ambient pressure and/or ambient temperatures. In other embodiments, the drying is supercritical drying. In further embodiments, the dried gel material comprises pore sizes from about 2 nm to about 100 nm. In additional embodiments, the pore sizes of dried gel materials may be about 4 nm, about 6 nm, about 8 nm, about 10 nm, about 12 nm, about 14 nm, about 16 nm, about 18 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, or about 95 nm.

The methods of the invention may also further comprise the presence of an additive before the use of any aging agent as described above. Thus an additive may be any added into a pre-gel, or pre-transfer, mixture of the invention. In some embodiments, an additive may be present with a precursor, a diluent, or a catalyst such that it is combined with other reagents along with the precursor, diluent, or catalyst. In cases of an additive with a precursor, the additive preferably does not increase instability in the precursor. In other embodiments, an additive is added to a first, or second, mixture of the invention. Where more than one additive is added, they can be added together or separately. A non-limiting example is a first additive added to a first mixture and a second additive added to a second mixture. An additive may be a solid or a liquid, with the latter allowing the use of a flow or stream of additive in a method of the invention.

Alternatively, additives may be added to any mixing area or mixer of the invention. In most embodiments where an additive is not present with a precursor, diluent, or catalyst before combination, the additive is in a separate container or location such that it is independently added in a method of the invention.

In some embodiments, an additive is an opacifying compound, a surface modifying chemical compound, a mechanical property enhancing chemical compound, a dust control compound, a hydrophobicizing compound, a flame retarding compound, a radiation minimizing compound, a radiation absorption enhancing compound, or any combination of two or more of the preceding. The addition of these additives may be viewed as doping with solids (IR opacifiers, sintering retardants, microfibers) to influence alter or change the physical and mechanical properties of the gel product. Suitable amounts of such dopants generally range from about 1 to about 40% by weight of the finished composite, such as from about 2 to about 30% using the methods of this invention. Opacifying compounds may be added to a mixture of the invention for added thermal performance, prior to or in conjunction, with the addition of catalyst(s) when gelation is induced. Opacifiers include, but are not limited to, B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide, or any combination of two of more of the foregoing. Methods for producing gel materials is also described in U.S. patent application Ser. No. 10/876,103 the entire contents of which is hereby incorporated by reference.

By keeping the solvent phase above the critical pressure and temperature during the entire, or at minimum the end of the solvent extraction process, strong capillary forces generated by liquid evaporation from very small pores that cause shrinkage and pore collapse are not realized. Aerogels typically have low bulk densities (about 0.15 g/cc or less, such as about 0.03 to about 0.3 g/cc), very high surface areas (generally from about 300 to about 1,000 m²/g and higher, such as about 700 to about 1000 m²/g), high porosity (about 90% and greater, such as greater than about 95%), and relatively large pore volume (about 3 mL/g, such as about 3.5 mL/g and higher). The combination of these properties in an amorphous structure gives the lowest thermal conductivity values (about 9 to about 16 mW/m-K at 37° C. and 1 atmosphere of pressure) for a coherent solid material.

The methods of the invention may also be viewed as processes of combining reagents to form porous gel materials. Many modes of practicing the invention may be performed by using appropriate stoichiometric ratios for the reagents used. One non-restrictive example is using about 65% diluent (such as ethanol as a non-limiting example), about 21% hydrolyzed alkylsilicate sol, such as partially hydrolyzed ethyl silicates as a non-limiting example, and about 14% catalyst (such as ammonia as a non-limiting example).

It is pointed out that the methods of the invention may be performed with multiple ingredients in each stream source (the stream sources being precursor, optionally hydrolyzed; diluent; catalyst; catalyst with additive; diluent with additive; hydrolyzed precursor with additive; etc.) Moreover, more than one gel precursor, more than one diluent and more than one catalyst can be concurrently used to conduct or practice the disclosed methods. Such ingredients can be housed together or separately, and co-streamed or separately streamed to achieve the same result as other embodiments presented.

The mixtures produced in the several embodiments of the present invention may be further processed to make a gel or gels produced in the several embodiments of the present invention may be further dried either at ambient pressures or at or above critical point of any of the fluid involved in the process or using a supercritical or a high pressure fluid. Carbon dioxide is a non-limiting example of a fluid which may be introduced in a liquid or gaseous form and further transformed into a supercritical condition and dried. Introduced liquid or gaseous carbon dioxide may replace existing fluid from the gel partially or completely and it can be further dried by taking the conditions above critical point of any of the fluids involved or a supercritical fluid itself may be used to replace the solvent in the gel and thus a dried gel or an aerogel is obtained.

In an embodiment, several sols or mixtures prepared as per the several embodiments of the present invention or the pre-gel mixtures are combined with a reinforcing component such as a fiber, fiber network, fiber web, fiber batting, lofty fiber batting, and the like and casted together. In a specific embodiment, casting is performed to obtain a sheet or blanket like cast comprising pre-gel mixtures and fiber reinforcements. The fibers may be made from a variety of materials natural and synthetic, organic or inorganic, simple or complex. Silica, alumina, zirconia, titania, calcium oxide or other oxides based materials may in combination or alone form fibers which could be useful in the embodiments. Organic fibers comprising materials such as polyesters, polyimides, polyacrylonitrile, carbonized or semi-carbonized forms of organic fibers are useful as well.

In an embodiment, fiber reinforced pre-gel mixtures cast into sheet or blanket form may be further rolled into a cylindrical form or more specifically in multiple layers and further processed. Further processing may include rinsing with a solvent such as alcohols, other chemical treatments such as a hydrophobic treatment or drying at ambient or high pressure drying. Drying may be performed using a liquid or gaseous carbon dioxide or supercritical carbon dioxide. Carbon dioxide may initially displace the fluid inside the gel before it completely or substantially dries the gels.

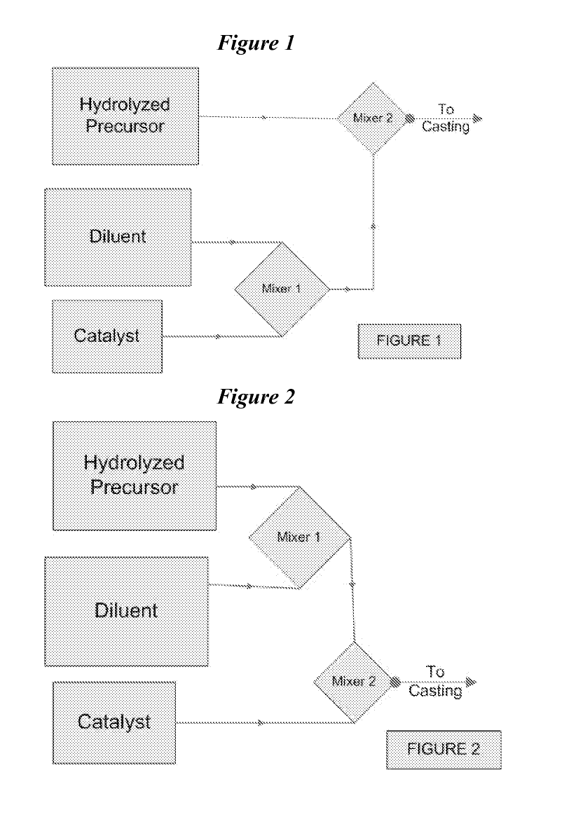

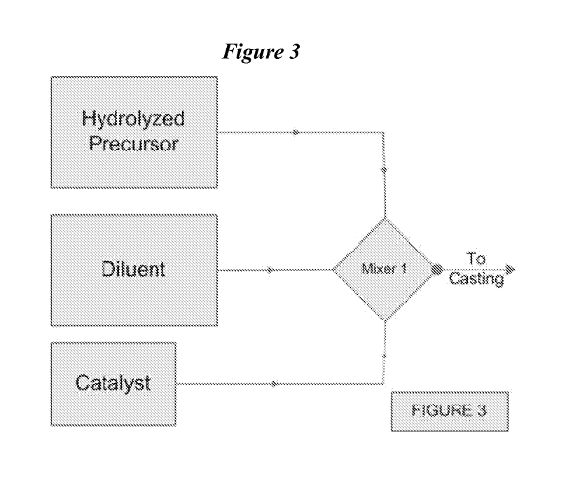

The following are specific, but non-limiting embodiments of the invention to aid in its understanding. They may be considered in combination with the systems shown in FIGS. 1-3. Features found in these embodiments, but not described elsewhere in the disclosure, may of course be used in combination with other aspects and embodiments of the invention as disclosed above and hereafter.

### EMBODIMENT 1

(1) The diluent, precursor, and catalyst are stored in separate containers or separate compartments of the same container(s).

(2) Optionally, the precursor is hydrolyzed with a minimum amount of diluent, water and catalyst (such as a base or acid) if the precursor is not already hydrolyzed.

(3) The desired ratio of the diluent and catalyst are streamed into a first area where mixing occurs.

(4) The hydrolyzed precursor, such as in a sol, and the diluent/catalyst solution are separately streamed into a second area, where mixing occurs, to form a catalyzed mixture or sol.

(5) Optionally, additives (such as, but not limited to compounds providing opacification, surface chemistry modification, modulus enhancement, flexibility enhancement, dust mitigation, hydrophobicity or hydrophilicity enhancement, combustion resistance, radiation absorption or reflection, etc.) are co-streamed with the catalyst or other reagents, or separately streamed, into the first or second mixing area.

(6) Consecutive portions of the catalyzed sol are transferred into a cast or mold in a continuous manner over a period of time. The cast or mold can be in motion or stationary. A cast or mold in motion, such as on or part of a conveyor assembly, preferably moves sufficiently slow to not disrupt, or not appreciably disrupt, gel formation.

(7) Optionally, after gelling, the porous gel material is enhanced by aging for a sufficient amount of time with an aging compound and/or at elevated temperatures but below the boiling point of the solvent entrained within the porous gel material.

(8) Optionally, subsequent to transferring the catalyzed sol and gelation thereof, drying the resulting gel into a xerogel using ambient condition drying, or into an aerogel using supercritical drying.

### EMBODIMENT 2

(1) The diluent, precursor, and catalyst are stored in separate containers or separate compartments of the same container(s).

(2) Optionally, the precursor is hydrolyzed with a minimum amount of diluent, water and catalyst (such as a base or acid) if the precursor is not already hydrolyzed.

(3) The desired ratio of hydrolyzed precursor and a diluent are streamed into a first area where mixing occurs to produce a hydrolyzed sol.

(4) The desired ratio of the hydrolyzed sol and a catalyst are streamed into a second area where mixing occurs to produce in a catalyzed sol.

(5) Optionally, additives (such as, but not limited to compounds providing opacification, surface chemistry modification, modulus enhancement, flexibility enhancement, dust mitigation, hydrophobicity or hydrophilicity enhancement, combustion resistance, radiation absorption or reflection, etc.) are co-streamed with the catalyst or other reagents, or separately streamed, into the first or second mixing area.

(6) Consecutive portions of the catalyzed sol are transferred into a cast or mold in a continuous manner over a period of time. The cast or mold can be in motion or stationary. A cast or mold in motion, such as on or part of a conveyor assembly, preferably moves sufficiently slow to not disrupt, or not appreciably disrupt, gel formation.

(7) Optionally, after gelling, the porous gel material is enhanced by aging for a sufficient amount of time with an aging compound and/or at elevated temperatures but below the boiling point of the solvent entrained within the porous gel material.

(8) Optionally, subsequent to transferring the catalyzed sol and gelation thereof, drying the resulting gel into a xerogel using ambient condition drying, or into an aerogel using supercritical drying.

### EMBODIMENT 3

(1) The diluent, precursor, and catalyst are stored in separate containers or separate compartments of the same container(s).

(2) Optionally, the precursor is hydrolyzed with a minimum amount of diluent, water and catalyst (such as a base or acid) if the precursor is not already hydrolyzed.

(3) The desired ratio of hydrolyzed precursor, at least one diluent, and at least one catalyst are streamed into a first area where mixing occurs to produce a catalyzed sol.

(5) Optionally, additives (such as, but not limited to compounds providing opacification, surface chemistry modification, modulus enhancement, flexibility enhancement, dust mitigation, hydrophobicity or hydrophilicity enhancement, combustion resistance, radiation absorption or reflection, etc.) are co-streamed with the catalyst or other reagents, or separately streamed, into the mixing area.

(5) Consecutive portions of the catalyzed sol are transferred into a cast or mold in a continuous manner over a period of time. The cast or mold can be in motion or stationary. A cast or mold in motion, such as on or part of a conveyor assembly, preferably moves sufficiently slow to not disrupt, or not appreciably disrupt, gel formation.

(6) Optionally, after gelling, the porous gel material is enhanced by aging for a sufficient amount of time with an aging compound and/or at elevated temperatures but below the boiling point of the solvent entrained within the porous gel material.

(7) Optionally, subsequent to transferring the catalyzed sol and gelation thereof, drying the resulting gel into a xerogel using ambient condition drying, or into an aerogel using supercritical drying.

Having now generally described the invention, the same will be more readily understood through reference to the following examples which are provided by way of illustration, and are not intended to be limiting of the present invention, unless specified.

### EXAMPLES

The following examples are offered to illustrate, but not to limit the claimed invention.

### Example 1

### Use of TEOS

The following may be viewed in consideration of FIG. 1.

(1) The hydrolyzed precursor (hydrolyzed TEOS) is flowed into the system at a flow rate of about 0.10 to about 0.50 gal/min. Rates of about 0.15, about 0.2, about 0.25, about 0.30, about 0.35, about 0.40, about 0.45 gal/min may also be used.

(2) The diluent (ethanol) is then run through the system at a flow rate of about 2.0 to about 2.5 gal/min. Rates of about 2.05, about 2.1, about 2.15, about 2.2, about 2.25, about 2.3, about 2.35, about 2.4, or about 2.45 gal/min may also be used.

(3) The catalyst is flowed into mixer 1 at about 0.20 to about 0.50 gal/min. Rates of about 0.25, about 0.3, about 0.35, about 0.4, or about 0.45 gal/min may also be used.

(4) Optionally an opacifying agent is co-streamed with the catalyst to obtain an opacified final product.

(5) A mixture of diluent and catalyst, and optionally opacifying agent, is achieved in mixer 1.

(6) The mixture of diluent/catalyst, and optionally opacifying agent, is flowed into mixer 2 with the hydrolyzed precursor (sol).

(7) The catalyzed sol is transferred continuously onto a mobile or stationary cast.

### Example 2

### Use of Partially Hydrolyzed Ethyl Silicate

A partially hydrolyzed ethyl silicate precursor preparation containing hydrolyzed precursors with silica content of about 26.7% by weight is used as a starting point. The overall volume to be prepared is 5 liters and 1 g/cc is the assumed overall density of the mixture. A system like that shown in FIG. 1 may be used in the practice of this example.

A gel with a target density of about 0.2 g/cc in the 5 liter volume would require 1000 g of silica, which is about 3745 g of the precursor preparation. The flow rate for the precursor preparation may be set to provide, to “Mixer 2” in FIG. 1, about 69.5% by weight of hydrolyzed precursor material and about 30.5% by weight of a mixture of diluent and catalyst, such as that from “Mixer 1” in FIG. 1.

A gel with a target density of about 0.02 g/cc in the 5 liter volume would require 100 g of silica, which is about 374.5 g of the precursor preparation. The flow rate for the precursor preparation may be set to provide, to “Mixer 2” in FIG. 1, about 7.5% by weight of hydrolyzed precursor material and about 92.5% by weight of a mixture of diluent and catalyst, such as that from “Mixer 1” in FIG. 1.

With both target densities, the percentages by weight of components is on a relative basis to a 100% total of all combined components prior to transfer. The flow rates may be adjusted based on the desired gel time and by using routine determination methods.

Thus gels with a range of densities from about 0.02 to about 0.2 g/cc may be prepared by using precursor material, from about 7.5 to about 69.5% by weight, in combination with a mixture of diluent and catalyst, from about 92.5 to about 30.5% by weight. With respect to the mixture of diluent and catalyst, the catalyst may be from about 20 to about 1%, which is present with the diluent (such as EtOH) from about 72.5 to about 29.5%, in the about 92.5 to about 30.5% of mixture.

### Example 3

### Alternative Use of TEOS

A precursor preparation containing hydrolyzed precursors with silica content of about 16.15% by weight is used as a starting point. The overall volume to be prepared is 5 liters and 1 g/cc is the assumed overall density of the mixture. A system like that shown in FIG. 1 may be used in the practice of this example.

A gel with a target density of about 0.15 g/cc may be prepared by setting flow rates to provide, to “Mixer 2” in FIG. 1, about 7.1% by weight of a mixture of diluent and catalyst, such as that from “Mixer 1” in FIG. 1, and about 92.9% by weight of hydrolyzed precursor material.

A gel with a target density of 0.02 g/cc may be prepared by setting flow rates to provide, to “Mixer 2” in FIG. 1, about 87.6% by weight of a mixture of diluent and catalyst, such as that from “Mixer 1” in FIG. 1, and about 12.4% by weight of hydrolyzed precursor material.

With both target densities, the percentages by weight of components is on a relative basis to a 100% total of all combined components prior to transfer. The flow rates may be adjusted based on the desired gel time and by using routine determination methods.

Thus gels with a range of densities from about 0.02 to about 0.15 g/cc may be prepared by using precursor material, from about 12.4 to about 92.9% by weight, in combination with a mixture of diluent and catalyst, from about 87.6 to about 7.1% by weight. With respect to the mixture of diluent and catalyst, the catalyst may be from about 35 to about 1%, which is present with the diluent (such as EtOH) from about 52.6 to about 6.1%, in the about 87.6 to about 7.1% of mixture.

All references cited herein, including patents, patent applications, and publications, are hereby incorporated by reference in their entireties, whether previously specifically incorporated or not.

Having now fully described this invention, it will be appreciated by those skilled in the art that the same can be performed within a wide range of equivalent parameters, concentrations, and conditions without departing from the spirit and scope of the invention and without undue experimentation.

While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

What is claimed is:

1. A method of continuously casting a porous gel material, said method comprising
continuously contacting at least one gel precursor with at least one diluent and at least one catalyst to form a pre-gel mixture, and
transferring said mixture into a cast in a continuous manner over time.
wherein either the precursor is from a separate source from the diluent and catalyst, or the catalyst is from a separate source from the precursor and diluent.

2. The method of claim 1 wherein said at least one diluent and at least one catalyst are contacted to form a first mixture before either is contacted with said at least one precursor.

3. The method of claim 2 wherein said diluent and catalyst are contacted in a first mixing area.

4. The method of claim 3 wherein said continuously contacting occurs in a second mixing area.

5. The method of claim 1 wherein said at least one gel precursor is maintained in a location separate from said at least one diluent and at least one catalyst.

6. The method of claim 3 wherein said diluent and catalyst are flowed into said first mixing area.

7. The method of claim 4 wherein said at least one gel precursor and said first mixture of diluent and catalyst are flowed into said second mixing area.

8. The method claim 1 wherein said transferring is of consecutive portions of the pre-gel mixture.

9. The method of claim 4 wherein one or both of said first and said second mixing areas are static or active mixers.

10. The method of claim 1 wherein said transferred pre-gel mixture gels to form a porous gel material.

11. The method of claim 10 further comprising aging the porous gel material.

12. The method of claim 10 further comprising drying the porous gel material.

13. The method of claim 12 wherein said drying comprises supercritical drying.

14. The method of claim 12 wherein said drying comprises the use of carbon dioxide.

15. The method of claim 1 wherein said at least one gel precursor comprises at least one of metal alkoxide monomer, metal oxide oligomer or metal oxide polymer.

16. The method of 15 wherein said metal alkoxide is silicon alkoxide or alkoxysilane.

17. The method of claims 2, further comprising addition of an additive to the first mixture.

18. The method of claim 17 wherein said additive is an opacifying compound, a surface modifying chemical compound, a mechanical property enhancing chemical compound, a dust control compound, a hydrophobicizing compound, a flame retarding compound, a radiation minimizing compound, a radiation absorption enhancing compound, or any combination of two or more of the preceding.

19. The method of any one of claims 1 wherein said at least one gel precursor comprises at least a hydrolyzed gel precursor.

20. A method of continuously casting a porous gel material, said method comprising
continuously contacting at least one gel precursor with at least one diluent to form a first mixture,
continuously contacting at least one catalyst with said first mixture to form a pre-gel mixture, and
transferring said pre-gel mixture into a cast in a continuous manner over time to form a continuous gel structure.

21. The method of claim 20 wherein said precursor and diluent and catalyst are contacted in a first mixing area or a second mixing area.

22. The method of claim 20 wherein before said contacting, the at least one gel precursor is maintained in a location separate from said at least one diluent and said at least one catalyst.

23. The method of claim 20 wherein said transferring is of consecutive portions of the pre-gel mixture.

24. The method of claim 20 wherein one or both of said first and said second mixing areas are static mixers.

25. The method of claim 20 wherein one or both of said first and said second mixing areas are active mixers.

26. The method of any one of claims 20 wherein said transferred pre-gel mixture gels to form a porous gel material.

27. The method of claim 20 further comprising a step of aging said porous gel material.

28. The method of claim 20 further comprising a step of drying said porous gel material.

29. The method of claim 28 wherein said drying comprises the use of a supercritical fluid, a gaseous fluid or a liquid, optionally the fluid is carbon dioxide.

30. The method of claim 20 wherein said at least one of metal alkoxide monomer, metal oxide oligomer or metal oxide polymer.

31. The method of claims 30 wherein said metal alkoxide is silicon alkoxide or alkoxysilane.

32. The method of claim 20 further comprising a step of adding an additive insaid first mixture or said second mixture.

33. The method of claim 32 wherein said additive is an opacifying compound, a surface modifying chemical compound, a mechanical property enhancing chemical compound, a dust control compound, a hydrophobicizing compound, a flame retarding compound, a radiation minimizing compound, a radiation absorption enhancing compound, or any combination of two or more of the preceding.

34. The method of claim 20 wherein said at least one gel precursor comprises atleast a hydrolyzed precursor.

35. A method of continuously casting a porous gel material, said method comprising
hydrolyzing, or subjecting to hydrolysis, gel precursor material to form at least one hydrolyzed gel precursor,
continuously contacting at least one hydrolyzed gel precursor with at least one diluent and at least one catalyst to form a pre-gel mixture, and
transferring said pre-gel mixture into a mold in a continuous manner over time to form a continuous gel structure.

36. The method of claim 35 wherein said precursor, diluent, and catalyst are contacted in a first mixing area or before said contacting, the at least one gel precursor is maintained in a location separate from said at least one diluent and said at least one catalyst.

37. The method of any one of claims 35 wherein said transferring is of consecutive portions of the pre-gel mixture.

38. The method of claim 36 wherein said first mixing area is a static or active mixer.

39. The method of any one of claims 35 wherein said transferred pre-gel mixture gels to form a porous gel material and optionally aging such porous gel material.

40. The method of claim 35 further comprising a step of drying said porous gel material.

41. The method of claim 40 wherein said drying comprises the use of a supercritical fluid, a gaseous fluid or a liquid, and optionally the fluid is carbon dioxide.

42. The method of claim 35 wherein said at least one of metal alkoxide monomer, metal oxide oligomer or metal oxide polymer.

43. The method of any one of claims 42 wherein said metal alkoxide is silicon alkoxide or alkoxysilane.

44. The method of claim 35 further comprising a step of adding an additive.

45. The method of claim 44 wherein said additive is an opacifying compound, a surface modifying chemical compound, a mechanical property enhancing chemical compound, a dust control compound, a hydrophobicizing compound, a flame retarding compound, a radiation minimizing compound, a radiation absorption enhancing compound, or any combination of two or more of the preceding.
